(19) United States
(12) Patent Application Publication
(10) Pub. No.: US 2010/0295671 A1
(43) Pub. Date: Nov. 25, 2010

(54) DATA PORT AND TRANSMISSION DEVICE

(76) Inventors: Jeffrey M. Sweeney, Olathe, KS (US); Kelsyn D. S. Rooks, Overland Park, KS (US); Jim Kevin Edwards, Leawood, KS (US)

Correspondence Address: Woodard, Emhardt, Moriarty, McNett & Henry LLP, 111 Monument Circle, Suite 3700, Indianapolis, IN, 46204-5137, US

(21) Appl. No.: 12/469,320

(22) Filed: May 20, 2009

(51) Int. Cl. G08B 1/08; G08B 21/00; H04Q 1/30; H04M 11/04

(52) U.S. Cl. 340/533; 340/540; 340/539.1; 379/37

(57) ABSTRACT

Among other things, there are disclosed devices and methods for monitoring sensors in a home, office or other location and transmit low-bandwidth signals concerning those sensors along existing telephone wires not connected to telephone service. A hub device is electronically connected to one or more sensors at an end user's location, and is also electronically connected to the unused telephone wires. When a sensor transmits a signal to the hub, such as a smoke detection or other problem, the hub creates a low-bandwidth signal and transmits it along the unused telephone wires. A converter remote from the end user's location receives the signal, converts it into data or other type of message, and sends the message to the end user or other service for action.

The present disclosure concerns structure and methods for better and more cost-effective monitoring and notification of conditions noted by sensors.

### BACKGROUND

Systems for monitoring conditions in a home, business, laboratory or other location are known, and commonly include electronic detectors that are dedicated to reacting to certain environmental or other situations. For example, smoke alarms are prevalent in inhabited buildings of all kinds. Electronic switches or connections on windows and doors can indicate the opening or closing of the door or window. Temperature or humidity sensors can provide information as to the living conditions in a room, home or building.

These and many other electronic devices are used to provide data concerning an environment and/or to guard against undesirable or dangerous situations such as fire or unauthorized entry. Security systems, for monitoring premises for entry, fire and other safety concerns, include sensor devices connected by wire to active outgoing wires of the hard-wired landline telephone service. When an undesirable or dangerous condition is detected, an alarm signal is sent by dialing out on the landline connection to an alarm service, which in turn notifies the property owner or lessor or proper authorities. For example, in the case of a fire, a smoke or heat detector sends a signal to a dial-out device. The telephone number of a monitoring service or agency is dialed, in a manner similar to that of a telephone modem, and the existing landline service is used to send a signal to the agency. The agency then contacts the fire department and relays the location and report of a potential fire.

Several problems exist with these kinds of monitoring systems. Among them are the number of intermediaries between the detector and the actual distribution of information concerning the environment. Further, the use of the telephone line by the alarm system can produce undesirable effects. If the telephone is in use when the dial-out device begins operation, the call is disconnected so that the alarm call can go through. If the original call is to an emergency service, then valuable time and information can be lost if the call is terminated. Of course, if the dial-out device is not set up to disconnect a call in progress, then the transmission of the alarm must wait until the original call ends. Further, there is the expense to the end-user of connecting a security system to active telephone landlines. As soon as the system is connected, monthly charges accrue not only for the active monitoring of the system by a service, but also the telecommunications tariffs and taxes mandated by federal and state law for use of voice-traffic lines.

Home automation systems are known that include sensor devices that have broadband connectivity via a wireless router. Signals concerning the automated device(s) are sent and received over the broadband connection. However, there are potential security problems with broadband and other internet connections, and of course the existence and proper operation of a sometimes expensive broadband service is needed. Such a service is expensive to the service provider to create and maintain, and is costly to the end user in terms at least of subscription fees, the need for routers or other broadband equipment, and potential for interruption or unauthorized use of wireless routers. Utilities sometimes leverage such wireless systems to remotely upload consumption or usage information, potentially invading the privacy of the user.

### SUMMARY

Among other things, there is disclosed a system for communicating the status of one or more sensors at an end user's location, which includes a data hub and communication device at the end user's location. The device is electronically connected to the one or more sensors at the end user's location, and to a dedicated copper line via a telephone jack and receptacle. The device is also connected to a source of electricity separate from the dedicated copper line. A converter is located in a telephone network remote from the end user's location, and is electrically connected to the dedicated copper line and has a separate output. The hub device is adapted to send low-bandwidth signals representing output of sensor(s) over the dedicated copper line to the converter, and the converter is programmed to receive the signals, to identify whether they represent an event-based threshold alarm, and to transmit a message from its output when an event-based threshold alarm is identified.

In other embodiments, the system's receptacle and/or jack includes two twisted wire pairs, and the dedicated copper line is one of the twisted wire pairs, or the jack and/or receptacle may have only one twisted wire pair, with that pair being the dedicated copper line. The output of the converter is adapted to send the at least one message to an end user or third party. The converter's output may be connected to a means for sending the message(s). Messages can be in the form of one or more of internet protocol packets, facsimile, RS-232, modem, custom application programming interface, wireless communications, web-based services, and e-mail.

In particular embodiments, the low-bandwidth signals are voltage-based signals using modulation of one or more of voltage level and temporal duration. Sensors may be hardwired to the hub device, or wirelessly electronically connected to the hub device.

Also disclosed are embodiments of methods, including in certain embodiments providing a hub adapted to receive signals from one or more sensors at an end user's location, the hub being electrically connected to a dedicated copper line via a telephone jack and receptacle, and to an electrical source separate from the line. A converter is provided remote from the hub, with the converter electrically connected to the dedicated copper line. A signal is received in the hub from one of the sensors, the signal indicating an event-based threshold alarm from one of the sensors. A low-bandwidth secondary signal is transmitted from the hub via the dedicated copper line to the converter, which secondary signal is created and transmitted through electricity from the hub and represents information of the event-based threshold alarm and the location of the hub. The secondary signal is received by the converter, and the converter generates and transmits a data message, the message indicating the location of the hub device and the nature of the event-based threshold alarm.

In other embodiments, the secondary signal is a voltage-based signal using modulation of one or more of voltage level and temporal duration. The hub may be provided at the end user's location, and draws electrical power from an electrical outlet at the end user's location. Message(s) generated and transmitted by the converter may be internet protocol packets, facsimile, RS-232, modem, custom application programming interface, wireless communications, web-based services, and e-mail. The hub further determines whether signals received from sensor(s) represent an event-based threshold alarm. The event-based threshold alarm may be one or more of detection of smoke, detection of unauthorized entry and malfunction of a device. The dedicated copper line includes two wire pairs, and both of the wire pairs are used to transmit said secondary signal. The converter my be located at a central switching location of a public switched telephone network.

Methods are also disclosed that include generating a low-bandwidth voltage-based signal representing one or more data points reflecting one or more physical conditions at a first location used by an end user, transmitting the signal along a dedicated copper line, receiving the signal at a second location remote from the first location, and converting the signal to a data message. The message can be sent to the end user (e.g. the owner or lessee of the first location) or a third party, such as emergency services.

Voltage, polarity and frequency modulation can be used in order to convey information across unused twisted wire pairs of public switched telephone network (PSTN) lines, without requiring a traditionally provisioned telephone line or any landline service at all. The system generates voltage back into the telephone network that is then interpreted by a network switch at a switching location. Voltage generated at the end user's premises means the cost of the electricity for the transmission is at the end user's expense, rather than being generated at or by the switching location or telephone network.

The sensors gather information from devices or environments and pass signals regarding them to a hub device as a central conduit. The hub device generates a secondary signal that passes out of the home or building on a dedicated copper line in existing telephone infrastructure and to a converter. The converter receives the secondary signals and converts them to a data message for others, thus providing basic intelligence to the end user or a third party for identifying and acting upon event-based threshold alarms or other information.

The disclosed structure and methods leverage traditional and existing PSTN infrastructure to provide a wide-ranging and cost-effective platform for a variety of building monitoring solutions. Such solutions can be offered directly by a landline or other telephone service provider to the end user (e.g. home- or business-owner), or can form a platform for others to offer services to end users. The cost to the service provider of operation of this type of system is reduced at least due to the use of the end user's electrical power, and the cost to the end user is reduced due to the use of otherwise unused telephone lines, which are not subject to the range of fees and taxes applicable to voice lines.

### BRIEF DESCRIPTION OF THE DRAWINGS

FIG. 1 is a schematic representation of an embodiment of a monitoring system as disclosed herein.

FIG. 2 is a schematic representation of a sensor hub and communications device indicated in FIG. 1.

FIG. 3 is a top plan view of a telephone jack.

FIG. 4 is a front view of a receptacle for the jack of FIG. 3.

FIG. 5 is a schematic representation of a converter indicated in FIG. 1

FIG. 6 is a flow chart indicating an embodiment of a method of using the system shown in FIG. 1.

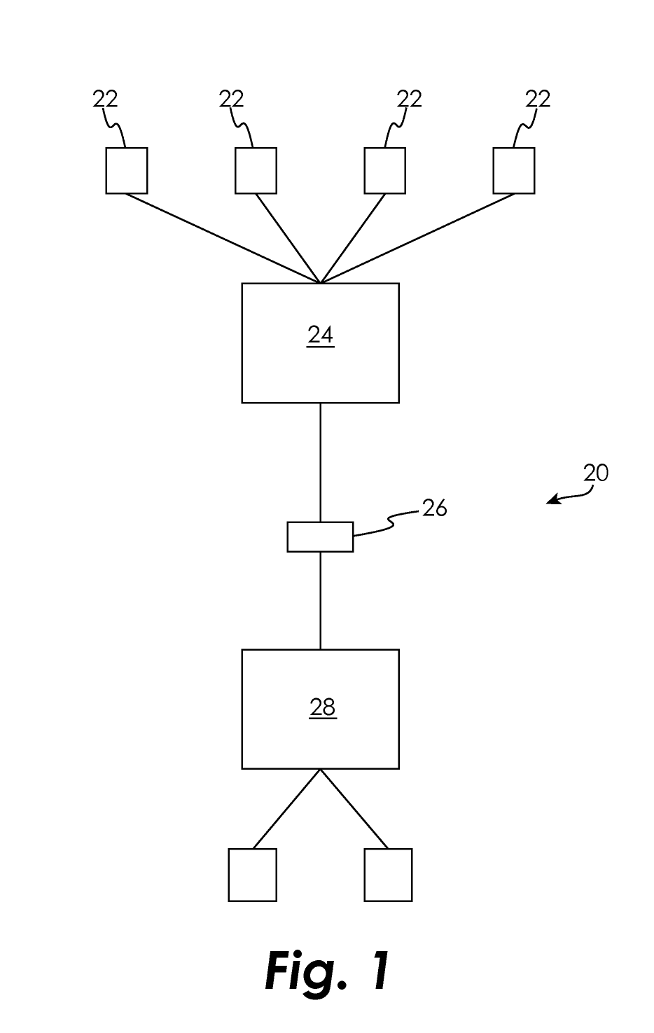

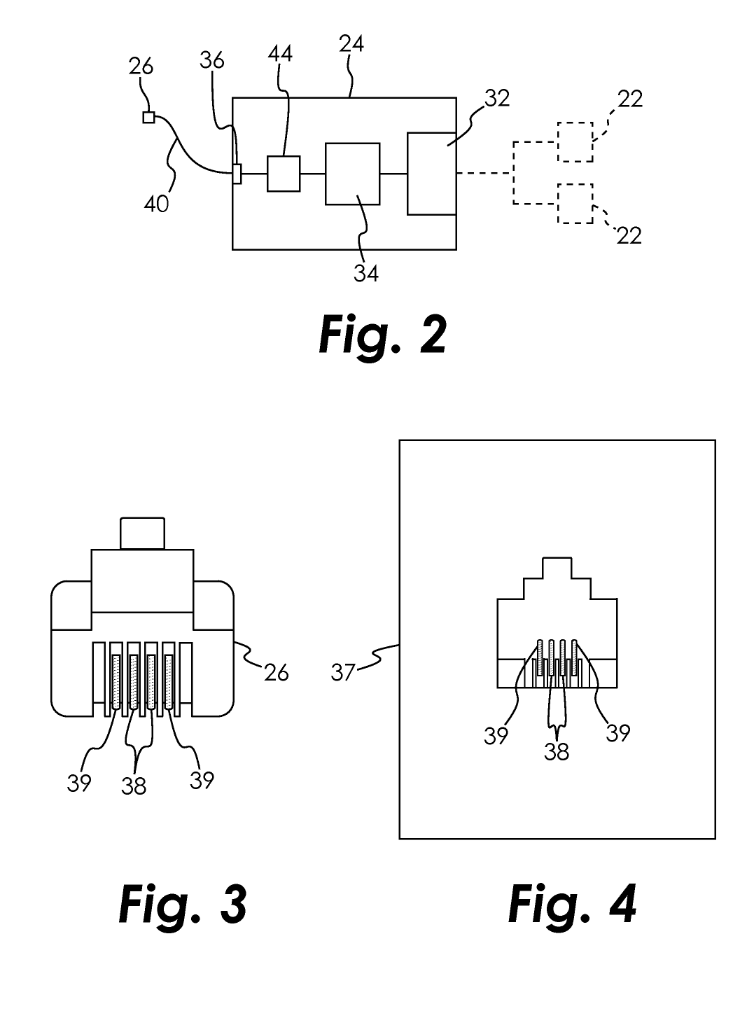

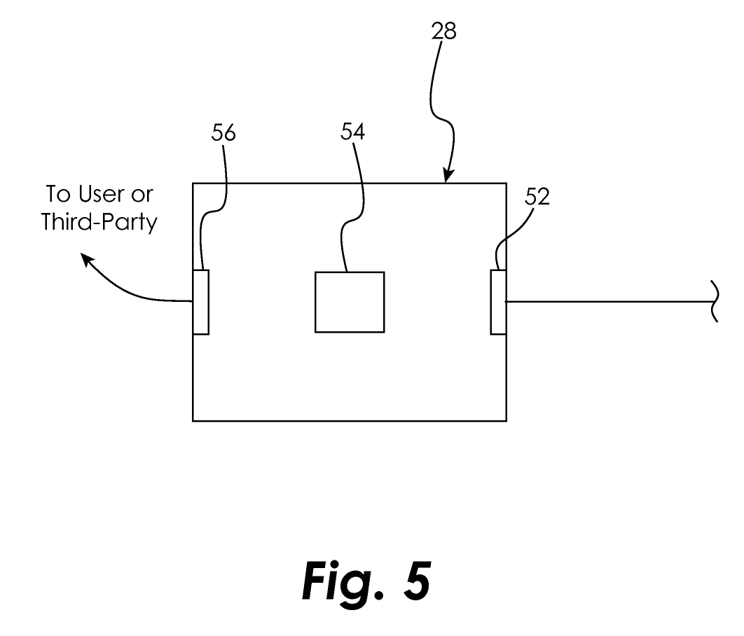

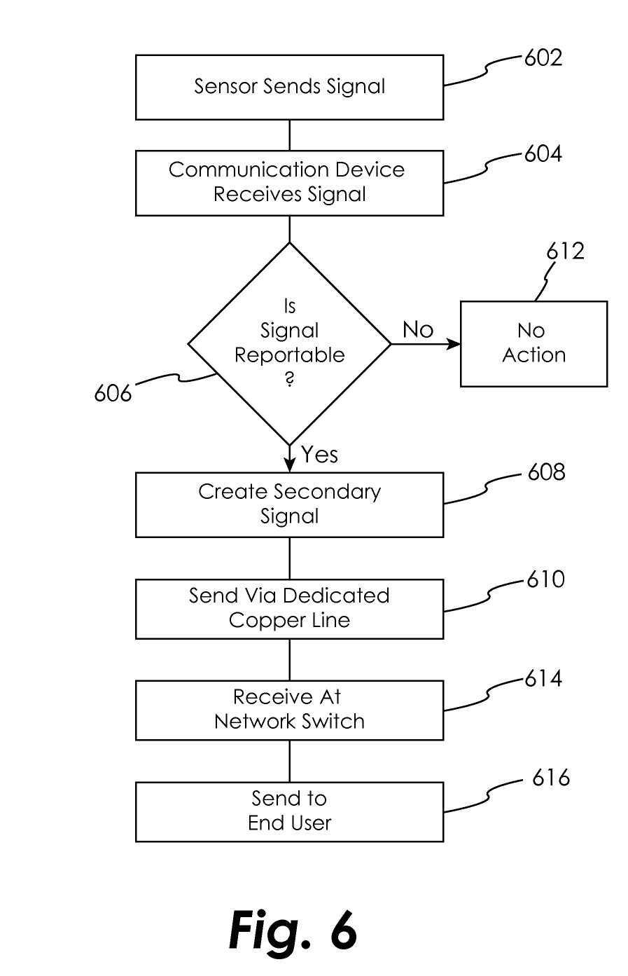

### DETAILED DESCRIPTION OF THE PREFERRED EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claims is thereby intended, and alterations and modifications in the illustrated device, and further applications of the principles of the disclosure as illustrated therein are herein contemplated as would normally occur to one skilled in the art to which the disclosure relates.

Referring now to the drawings, there is indicated a system 20 for transmitting data concerning the status of an environment or of devices in a home, office or other building. Generally speaking, system 20 includes one or more sensors 22 for collecting data or monitoring the status of an environment or device. A sensor hub 24 is electronically connected to sensors 22, and is separately connected to an unused dedicated copper line of a telephone jack 26. As described further below, hub 24 is a platform for receiving data or other output from sensors 22 and generating signals to be sent along the dedicated copper line. A signal converter 28 is provided remote from the location of hub 24 but in electrical connection with the unused dedicated copper line of telephone jack 26. Converter 28 has an output which can be transmitted to a desired location or device, as will be explained further below.

Sensors 22 may be any of a variety of sensors that monitor the environment or the operation of a device. Safety devices such as smoke, carbon monoxide or other contaminant detectors may be among sensors 22. Entry monitors of all kinds, such as door-specific or window-specific devices designed to connect or break a circuit if the door or window is opened may be among sensors 22. The variety of sensors that measure other types of environmental data, such as temperature, humidity, concentration of salt or other substances, or light or other types of radiation intensity, may also be among sensors 22. Sensors 22 could also include monitors that report whether household appliances, computers or other devices are on or off, or are operating as desired.

Sensors 22 provide an output of data to hub device 24. Sensor(s) 22 provide a signal to hub 24 at such time as sensor(s) 22 note an unusual, abnormal or other reportable condition (which may be termed an “event-based threshold alarm”). In the case of a smoke detector sensor, such a condition could be the presence of smoke, while a salinity or temperature sensor may report when the concentration or heat is above or below desired limits. For an entry sensor, the opening of a door or window that breaks or closes a circuit may be sensed. Sensor(s) 22 may also provide periodic signals to indicate normal conditions, e.g. no presence of smoke, concentrations within a desired range, or lack of entry.

In certain embodiments, signals sent from sensor(s) 22 identify not only the existence of the reported condition, but also the particular sensor(s) 22 that have detected the condition, and they may also give the magnitude of the condition (e.g. the temperature or concentration value). For example, one or more sensors 22 may be hard-wired to hub 24, such as at a predetermined input of hub 24, so that a signal received at that input automatically identifies the sensor 22 from which the signal came. In other embodiments, one or more sensors 22 may be connected via plug-in connections, wireless connections or other interfaces to hub 24. For example, programming in hub 24 may be configured so that an initial plug-in or wireless “handshake” between sensors 22 and hub 24 similarly provides an automatic identification by programming in hub 24 that a particular received signal came from a particular sensor 22.

To summarize, such wired or wireless sensor(s) 22 are installed or deployed by an end user or other party for monitoring home or business automation, security access points or systems, energy consumption devices or systems, electronic equipment or appliances, environmental data, and other devices or information. In particular, sensor(s) 22 may provide event-based threshold alarms (i.e. significant smoke, high concentration of contaminants or other report-worthy occurrences), operating status of devices, and/or other types of information regarding health, status or proper functioning of equipment, systems or environments being monitored.

Sensor hub 24, in one embodiment, is a low-bandwidth customer-premises equipment (CPE) device. It is installed at an end user's home, business or other building, and in a particular embodiment is plugged directly or via intermediate cable into a wall outlet to draw electrical power. It will be understood that electrical power may come from self-contained sources, such as rechargeable or non-rechargeable batteries. In this way, electricity used by hub 24 in this embodiment comes from the device itself or from the end user's electrical service.

Hub 24 includes one or more inputs 32 for accepting signals from sensor(s) 22. The types of input(s) 32 will depend on how the sensor(s) 22 are connected to hub 24. If hardwired, then input(s) 32 will be connections between wires from sensor(s) 22 and receiving and analyzing structure in hub 24 such as appropriately configured integrated circuits or chips. Input(s) 32 may be any of a variety of sockets for plug-in connections, or may be wireless interfaces. In a particular embodiment, each sensor 22 is electronically connected to a discrete input 32, so that the particular input 32 that receives a signal is an indication of which sensor supplied the signal. For example, if a smoke detector is linked to input A and an entry detector to input B, then a signal received at input A automatically indicates that the signal is from the smoke detector, and a signal received at input B automatically tells device 24 that the signal is from the entry detector. In other embodiments, signals from each sensor 22 include a portion or datum that identifies the particular sensor.

Signals from sensor(s) 22 are received by hub device 24 via input(s) 32, and programming (e.g. hardware, firmware and/or software) 34 in data device 24 receive the signals and convert them to a voltage-based signal. If sensor(s) 22 are configured to send both reportable event-based signals (e.g. smoke, unauthorized entry or environmental statistic out of range) and signals representing normal conditions, then the programming 34 determines from the signal whether it is a reportable signal or a condition-normal signal. The signal itself may include not only information identifying the sensor 22 from which it came, but also a bit or portion identifying the signal as reportable. In that case, hub 24 need only test the bit or portion relating to reportability. Of course, if sensor(s) 22 only send signals when the condition(s) monitored is reportable, then hub 24 will automatically accept the signal for reporting. Thus, hub 24 acts as a receiving platform for signals from one or more wired or wireless sensors located in an individual home or business.

An output 36 is provided in data device 24, which is connected to a dedicated copper line of telephone jack 26 in the end user's building. As used herein, “dedicated copper line” means the unused twisted wire pair where the end user has landline telephone service, or any available twisted wire pair where the end user has no landline telephone service. FIGS. 3-4 show a representation of a standard RJ-11 jack 26 and its wall receptacle or connection 37. Jack 26 has an inner pair of wires 38 and an outer pair of wires 39. In most landline telephone wiring set-ups, each wall jack includes four wires in two twisted pairs. Where the landline service is connected, one of the pairs (wires 38) carries telephone signals to and from jack 26, and the other pair (wires 39) is unused in the landline service, and thus is a dedicated copper line. When no landline service exists, both pairs 38 and 39 are unused, and both are dedicated copper lines.

In the particular case of a standard RJ-11 telephone jack/receptacle in the wall, output 36 may be a similar or identical socket. A telephone cord or cable 40 connects output 36 of data device 24 via jack 26 to wall connection 37. In one embodiment, cable 40 and output 36 are outwardly identical to existing receptacles and cords, but include only the twisted wire pair needed to connect to the dedicated copper line in jack 26 and receptacle 37, i.e. inner wires 38.

Hub device 24 also includes a signal transmitter 44 electronically connected to output 36. When a signal from input(s) 32 is determined by programming 34 of hub device 24 to warrant reporting, signal transmitter 44 generates a signal identifying one or more of (a) the location and/or end user associated with hub 24, (b) the sensor 22 issuing the reportable signal and/or the device or system it monitors, and (c) the status or condition that was sensed. For example, in a case where a smoke detector sensor 22 sends a signal to hub 24 indicating the presence of significant smoke, signal transmitter 44 creates a secondary signal that includes information representing the particular hub 24 and/or its location, the particular smoke detector that sent the initial signal to hub 24, and a code for the presence of smoke. Similarly, if a temperature sensor signals to hub 24 that a temperature is too low, signal transmitter 44 creates a secondary signal with information representing the hub device 24, the particular sensor, and may include data indicating the actual measured temperature.

The secondary signal is a voltage-based signal that passes along the dedicated copper line. The electricity used in the transmission of the secondary signals originates from device 24, via wall outlet at the end-user's building or premises or self-contained power such as a battery. In a particular embodiment, hub 24 uses a 48 volt direct current (DC) signal to transmit such secondary signals, and thus conversion circuitry to modify wall outlet voltage (commonly 110 volts AC in the United States) to 48 volts DC may be included in hub device 24. In various embodiments, the secondary signal may be modulated for voltage (e.g. at 48 volts, 24 volts, 12 volts, etc. of direct current) and/or for polarity. The timing of the signal and modulation may also be modified to occur with certain time frequencies. Each of these factors—shifts in voltage, polarity and timing—and/or others can be used to create a low-bandwidth voltage signal representing a particular sensor device 22 and/or a data point to be tracked (e.g. whether a device is on or off, or whether a threshold alarm has been triggered, etc.). That is, data points as received by hub 24 (which may indicate the originating sensor as well as location and condition) are converted by programming 34 in hub 24 into voltage signals that have a specific combination, sequence, duration, and/or levels of voltage and which are transmitted from signal transmitter 44. As a specific illustration, these voltages could represent a “Morse code” type of transmission, with variations in voltage level and length of voltage “bursts” conveying data or messages. It will be understood that there may be limits in the system as to the ability to distinguish or detect narrow changes in voltage, but sequencing variations in voltages and duration(s) of each voltage level are practically unlimited. That large number of possible combinations of voltage levels, sequences and duration result in a wide variety of secondary signals or “data codes” from signal transmitter 44, indicating association with specific sensors, data points and events. Hub 24 thus receives signals from sensor(s) 22, and translates those signals into the secondary signals (e.g. voltage signals) or data codes sent on by signal transmitter 44.

Converter 28 is a hardware and software device akin to a telephone network switch at least in that they are similarly placed in the telephone network and they have a general use in directing signals. In some embodiments, the network switch at the central office or other switching station to which the end user's copper telephone line is connected may be disconnected to one or both wire pairs 38 and 39, preventing the use of POTS (“plain old telephone service”) along the wire pair(s). Converter 28 is inserted and electronically connected to the dedicated copper wire pair(s) (e.g. wires 39 and/or 38) to which hub 24 provides signals (e.g. a “subscriber loop”). Converter 28 receives the secondary signals generated and sent by signal transmitter 44 via the dedicated copper line. Converter 28 is located away from the end user's location (the site of hub 24), and in particular embodiments is located in or around a central telephone office or switching site.

Converter 28 has an input 52 for receiving secondary signals (such as voltage-based signals) from signal transmitter 44. Programming 54 (e.g. hardware, firmware and/or software such as embodied in integrated circuitry) in converter 28 processes the received secondary signals to extract the information in them. On receipt of a secondary signal relating to an event-based threshold alarm or other reportable event, programming 54 generates a communication relaying the information, which is sent to output port 56. This outbound communication in certain embodiments is a standard transmission to other device(s), e.g. by electronic data transfer (such as internet protocols, facsimile, RS-232, modem, custom application programming interface (API), wireless communications (e.g. to the end-user's Bluetooth or ZigBee devices), web-based services, e-mail) to an end user, monitoring service, emergency services, or other party or device. The outbound communication can also be a voice transmission by telephone to the end user or other party. The communication includes necessary information for stating the location, condition, health, operating status and/or proper functioning of equipment or system that is being monitored.

Methods of installing and using system 20 will be understood from the foregoing discussion. The CPE sensor hub 24 is provided to the end user for installation at his or her home, office or other site. Hub 24 is plugged into a wall socket to draw electricity. As noted above, hub 24 may include batteries (rechargeable or not) as a principal power source or a backup, and if so, then initial plugging into a wall socket may not be necessary. Sensors 22, each associated with respective devices, conditions or other monitorable sources, are connected via wire or wireless connection to hub 24. Hub 24 is connected to a telephone receptacle 37 via a cable with jack 26, so that hub 24 has an electronic communication path to a dedicated copper line in the receptacle 37. Alternatively, hub 24 may have an integral jack 26 that mates to telephone receptacle 37 without the need for a cable. Converter 28 is placed remotely from the end user's site, e.g. toward or at a central switching location or office, and is electronically connected to that dedicated copper line. An output of switch 28 is further connected to one or more communication lines or systems so that a communication from switch 28 can reach an end user, monitoring service, emergency responder or other party as noted above.

In use, the one or more sensors 22 monitor the devices, conditions or environmental factors for which they are designed. In some cases, sensors 22 send periodic signals to hub 24 (step 602), which generally reflect normal conditions or operations. In other cases, sensors 22 only send signals when an event-based threshold alarm (e.g. smoke, high temperature) or other reportable result occurs. Hub 24 receives (step 604) and interprets (step 606) the signals sent by sensors 22. For those signals representing an event-based threshold alarm or other reportable result, hub 24 generates (step 608) and sends (step 610) a secondary signal with information representing, for example, the location of the sensor, the particular sensor, and/or the magnitude or other particular information relating to the reportable result. As noted above, the secondary signal in particular embodiments is derived from a voltage input at the end-user's site. For those signals that do not represent an event-based threshold alarm or other reportable result, no secondary signal is generated by hub 24 (step 612).

The secondary signal leaves output 36 of data device 24 via jack 26 and receptacle 37 through the dedicated copper line 38 to converter 28. Converter 28 receives the secondary signal and interprets it to obtain the information embodied or encoded in it (step 614). For example, it converts voltage signals as discussed above into data, plain-text communication or other message. If the information indicates a condition to be reported, converter 28 sends the message via output 56 to communicate with the end user, emergency services, a monitoring service, or another third party and inform them of the signal (step 616). The location, sensor and event data are communicated to the third party, such as in an e-mail, text message or other communication, notifying that smoke has been detected by a kitchen smoke detector at the end user's home.

Shifts in voltage, polarity and timing can be interpreted by converter 28 as the output of the various sensors 22 connected to hub device 24. Each sensor 22 and each data point being tracked in each wireless sensor device would be identified in accordance with a specific combination, sequence, duration and level of voltage. Periodic or constant data being pushed and/or pulled from each sensor device 22 to and/or from hub 24 are transmitted over the dedicated copper line to converter 28, utilizing specific combinations of the above modulated signals.

The disclosed structure and methods provide for the creation of low-bandwidth data service solutions that utilize traditional public switched telephone network (PSTN) infrastructure. It offers an alternative use of the in-ground copper plant of the PSTN, particularly through use of unused twisted pairs of copper telephone wires that convey non-voice signals such as the voltage-based signals noted above. The system can be configured to serve as a data port and transmission device for in-building monitoring of a variety of conditions, including energy usage, appliance and electronic device status (e.g. off or on, or how the device is operating), security systems, automation systems, and the like. A telephone service (landline) provider with apparatus and methods as described above can offer new home or building monitoring products and services directly to the end user. A wholesale service delivery platform can be created with such turn-key accessibility and connectivity, which can benefit the platform provider or other companies or service providers. The disclosed systems and methods do not require the expense and special infrastructure involved with a broadband connection, and they do not use a telephone line that is provisioned for standard telephone service, so that the usual telecommunications tariffs, taxes and other fees do not apply. Furthermore, in some embodiments all of the energy used to create and send the signals over the unused twisted pair is supplied by the end user.

It will be understood that in some cases the initial signal and the secondary signal will be the same thing. As one example, if the output of sensor(s) 22 is a voltage-based signal, it can be passed through hub 24, without modification or with the addition of one or more additional data such as the location of hub 24, and sent on to converter 28 for analysis and action as described above.

While subject matter has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

What is claimed is:

1. A system for communicating the status of one or more sensors at an end user's location, comprising:
a data hub and communication device at the end user's location, said device being electronically connected to the one or more sensors at the end user's location, said device being electronically connected to a dedicated copper line via a telephone jack and receptacle; and
a converter located in a telephone network remote from said end user's location, said converter electrically connected to said dedicated copper line and having a separate output,
wherein said device is adapted to send low-bandwidth signals representing output of the one or more sensors over said dedicated copper line to said converter, said converter being programmed to receive said signals, to identify whether said signals represent a reportable result, and to transmit at least one message from said output when a reportable result is identified.

2. The system of claim 1, wherein at least one of said jack and said receptacle includes two twisted wire pairs, and said dedicated copper line is one of said twisted wire pairs.

3. The system of claim 1, wherein at least one of said jack and said receptacle has only one twisted wire pair, said pair being said dedicated copper line.

4. The system of claim 1, wherein said output of said converter is adapted to send said at least one message to an end user or third party.

5. The system of claim 4, wherein said output is connected to a means for sending said messages.

6. The system of claim 4, wherein said messages are in the form of one or more of the group consisting of: internet protocol packets, facsimile, RS-232, modem, custom application programming interface, wireless communications, web-based services, and e-mail.

7. The system of claim 1, wherein said low-bandwidth signals are voltage-based signals using modulation of one or more of voltage level and temporal duration.

8. The system of claim 1, wherein said sensors are hardwired to said device.

9. The system of claim 1, wherein said sensors are wirelessly electronically connected to said device.

10. The system of claim 1, wherein said device is connected to a source of electricity separate from said dedicated copper line.

11. The system of claim 1, wherein said reportable result comprises an event-based threshold alarm.

12. A method comprising:
providing a hub adapted to receive signals from one or more sensors at an end user's location, said hub being electrically connected to a dedicated copper line via a telephone jack and receptacle;
providing a converter remote from said hub, said converter electrically connected to said dedicated copper line;
receiving a signal in said hub from one of said sensors, said signal indicating a reportable result from said one of said sensors;
transmitting a low-bandwidth secondary signal from said hub via said dedicated copper line to said converter, said secondary signal representing information of the reportable result and the location of the hub;
receiving said secondary signal by said converter; and
generating and transmitting a data message by said converter, said message indicating the location of the hub device and the nature of the reportable result.

13. The method of claim 12, wherein said secondary signal is a voltage-based signal using modulation of one or more of voltage level and temporal duration.

14. The method of claim 12, wherein said hub is provided at the end user's location, and draws electrical power from an electrical outlet at the end user's location.

15. The method of claim 12, wherein said message generated and transmitted by said converter is a form from the group consisting of: internet protocol packets, facsimile, RS-232, modem, custom application programming interface, wireless communications, web-based services, and e-mail.

16. The method of claim 12, wherein said hub further determines whether signals received from said at least one sensor represent an event-based threshold alarm.

17. The method of claim 12, wherein said dedicated copper line includes two wire pairs, and both of said wire pairs are used to transmit said secondary signal.

18. The method of claim 12, wherein the event-based threshold alarm is one from the group consisting of: detection of smoke, detection of unauthorized entry and malfunction of a device.

19. The method of claim 12, wherein said converter is located at central switching location of a public switched telephone network.

20. The method of claim 12, wherein said device is connected to a source of electricity separate from said dedicated copper line.

21. The method of claim 12, wherein said reportable result comprises an event-based threshold alarm.

22. A method comprising:
generating a low-bandwidth voltage-based signal representing one or more data points reflecting one or more physical conditions at a first location used by an end user;
transmitting said signal along a dedicated copper line not used for landline telephone service;
receiving said signal at a second location remote from said first location;
converting said signal to a data message; and
sending said message to the end user or a third party.

23. A device for communicating the status of one or more sensors at an end user's location, comprising:
a data hub and communication device at the end user's location, said device adapted to be electronically connected to the one or more sensors at the end user's location, said device adapted to be electronically connected to a dedicated copper line that is not used for landline telephone service via a telephone jack and receptacle;
wherein said device is adapted to send low-bandwidth signals representing output of the one or more sensors over said dedicated copper line.
